(19) United States
(12) Patent Application Publication
(10) Pub. No.: US 2014/0172853 A1
(43) Pub. Date: Jun. 19, 2014

(54) GENERATING AND DISPLAYING TASKS

(71) Applicant: Google Inc., Mountain View, CA (US)

(72) Inventors: Ramanathan V. Guha, Los Altos, CA (US); Ramakrishnan Srikant, Cupertino, CA (US); Vineet Gupta, Palo Alto, CA (US); David Martin, Milpitas, CA (US); Mahesh Keralapura Manjunatha, Sunnyvale, CA (US); Andrew M. Dai, San Francisco, CA (US); Carolyn Au, Menlo Park, CA (US); Elena Erbiceanu, Mountain View, CA (US); Surabhi Gupta, Palo Alto, CA (US); Matthew D. Wytock, San Jose, CA (US); Carl R. Lischeske, III, San Francisco, CA (US); Vivek Raghunathan, Fremont, CA (US)

(73) Assignee: Google Inc., Mountain View, CA (US)

(21) Appl. No.: 14/098,466

(22) Filed: Dec. 5, 2013

Related U.S. Application Data
(60) Provisional application No. 61/733,892, filed on Dec. 5, 2012.

(51) Int. Cl. G06F 17/30

(52) U.S. Cl. CPC G06F 17/30861
USPC 707/736

(57) ABSTRACT

Methods, systems, and apparatus, including computer programs encoded on computer storage media, for generating tasks from user observations. One of the methods includes segmenting a plurality of observations associated with a user of a user device into a plurality of tasks previously engaged in by the user; and generating a respective task presentation for each of the plurality of tasks for presentation to the user.

### CROSS-REFERENCE TO RELATED APPLICATION

This application claims priority to U.S. Provisional Application No. 61/733,892, filed on Dec. 5, 2012. The disclosure of the prior application is considered part of and is incorporated by reference in the disclosure of this application.

### BACKGROUND

This specification relates to providing information about Internet resources to users. Internet search engines aim to identify resources, e.g., web pages, images, text documents, and multimedia content, that are relevant to a user's information needs and to present information about the resources in a manner that is most useful to the user. Internet search engines generally return a set of search results, each identifying a respective resource, in response to a user-submitted query.

### SUMMARY

In general, one innovative aspect of the subject matter described in this specification can be embodied in methods that include the actions segmenting a plurality of observations associated with a user of a user device into a plurality of tasks previously engaged in by the user; and generating a respective task presentation for each of the plurality of tasks for presentation to the user.

The subject matter described in this specification can be implemented in particular embodiments so as to realize one or more of the following advantages. Users can easily resume tasks that they were previously engaged in. Users can be presented with relevant information about tasks that may be helpful in completing the tasks, e.g., information that has been viewed by other users that have engaged in similar tasks. User observations can be segmented into tasks that the user was engaged in without the user needing to identify the tasks. Users can quickly recall the actions they had taken when they were engaged in the task. Users can share the task with friends to help them accomplish their own task, and can edit or comment on the task for this purpose.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example task system.

FIG. 2 is a flow diagram of an example process for generating task presentations for tasks previously engaged in by a particular user.

FIG. 3 is a flow diagram of an example process for generating tasks from observations associated with a user.

FIG. 4 is a flow diagram of an example process for generating a name for a task.

FIG. 5 is a flow diagram of an example process for generating rules for mapping observations to types.

FIG. 6 is a flow diagram of an example process for generating recommended content for a particular task.

FIG. 7 is a flow diagram of another example process for generating recommended content for a particular task.

FIG. 8A shows an example task presentation displayed on a mobile device.

FIG. 8B shows an example expanded task presentation displayed on a mobile device.

Like reference numbers and designations in the various drawings indicate like elements.

### DETAILED DESCRIPTION

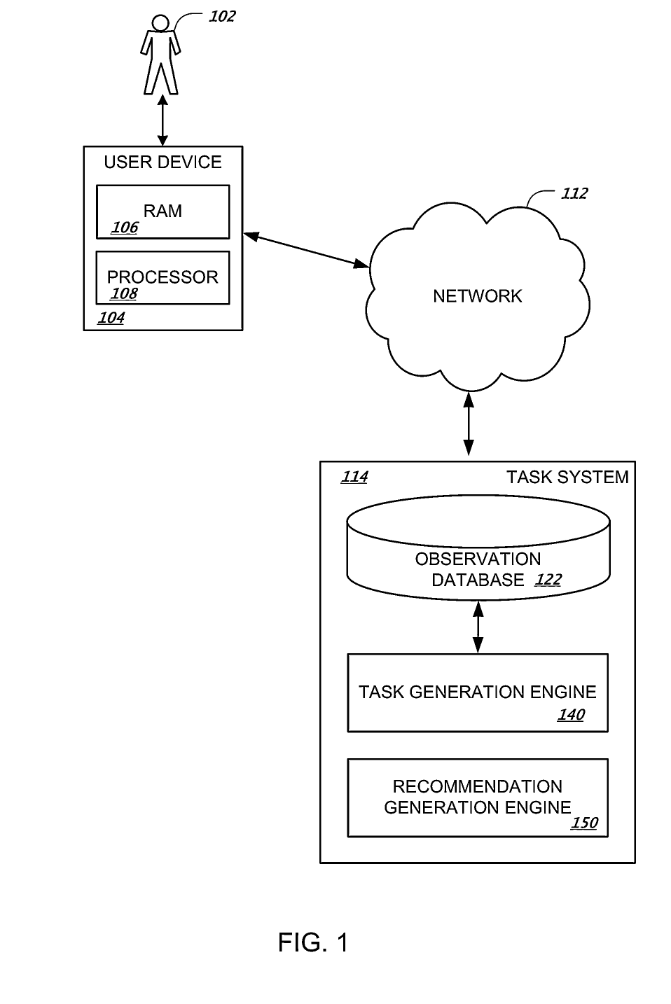

FIG. 1 shows an example task system 114. The task system 114 is an example of a system implemented as computer programs on one or more computers in one or more locations, in which the systems, components, and techniques described below can be implemented.

A user 102 can interact with the task system 114 through a user device 104. The user device 104 will generally include a memory, e.g., a random access memory (RAM) 106, for storing instructions and data and a processor 108 for executing stored instructions. The memory can include both read only and writable memory. For example, the user device 104 can be a computer coupled to the task system 114 through a data communication network 112, e.g., local area network (LAN) or wide area network (WAN), e.g., the Internet, or a combination of networks, any of which may include wireless links.

In some implementations, the task system 114 provides a user interface to the user device 104 through which the user 102 can interact with the task system 114. For example, the task system 114 can provide a user interface in the form of web pages that are rendered by a web browser running on the user device 104. As another example, e.g., if the user device 104 is a mobile device, the user interface can be presented as part of a particular application, e.g., a mobile application, that is running on the user device 104.

The task system 114 responds to task requests, i.e., requests to provide information about tasks that a user has previously engaged in on the Internet, by generating task presentations that identify tasks and include information about each of the tasks. A task is a collection of user actions that satisfy a common information need, e.g., accomplishing a specific objective, obtaining information about a specific topic, and so on. The task system 114 includes an observation database 122, a task generation engine 140, and a recommendation generation engine 150.

In this specification, the term “database” will be used broadly to refer to any collection of data: the data does not need to be structured in any particular way, or structured at all, and it can be stored on storage devices in one or more locations. Thus, for example, the observation database 122 can include multiple collections of data, each of which may be organized and accessed differently. Similarly, in this specification the term “engine” will be used broadly to refer to a software-based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The observation database 122 stores observations associated with users. An observation is a unit of data that is indicative of an action taken by a user. The observations may include direct observations, e.g., search queries that were submitted by a user to an Internet search engine, clicks made by the user on search results provided by the search engine, resources visited by the user, and so on. Although the user action with respect to a search result or a link to a resource is referred to by this specification as a “click” on the search result or the resource, the action can also be a voice-based selection, or a selection by a user's finger on a presence-sensitive input mechanism, e.g., a touch-screen device, or any other appropriate selection mechanism.

The observations may also include indirect observations, e.g., structured content from e-mail messages received or sent by the user, calendar entries or alerts identifying appointments, events, meetings, and so on. Structured content from e-mail messages received or sent by the user may be, e.g., content that is indicative of a purchase or an order placed by the user, e.g., a receipt, or travel purchased by the user, e.g., a travel itinerary or hotel reservation.

Observations can be associated with a particular user in the observation database 122 by virtue of being performed or received while the user is signed into a user account. Users may be given an option to have particular observations of their choice removed from the observation database 122 or to prevent any observations being stored in the observation database 122.

In some implementations, the task system 114 receives task requests for a given user on a periodic basis, i.e., at regular intervals. Optionally, when receiving a task request for a given user, the system may determine whether a sufficient number of observations have been associated with the user in the observation database 122 after the previous task request for the given user was received. If a sufficient number of observations have not been associated with the user after the previous task request, the system can respond to the task request by generating task presentations that identify the tasks generated for the user in response to the previous task request.

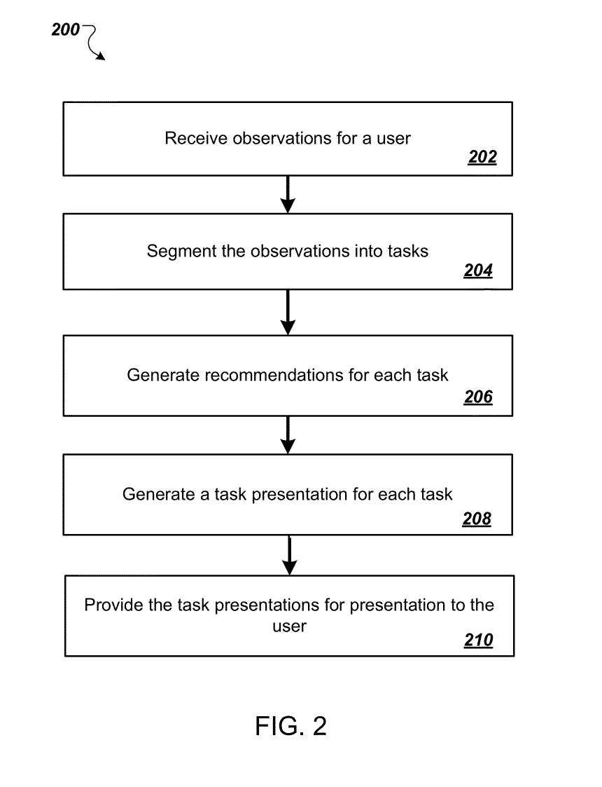

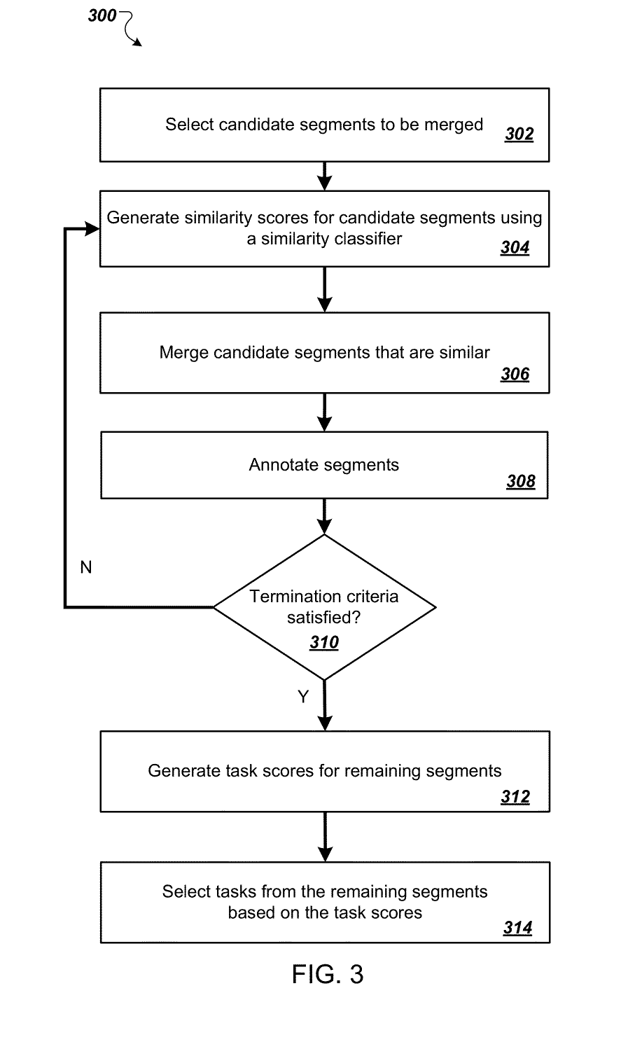

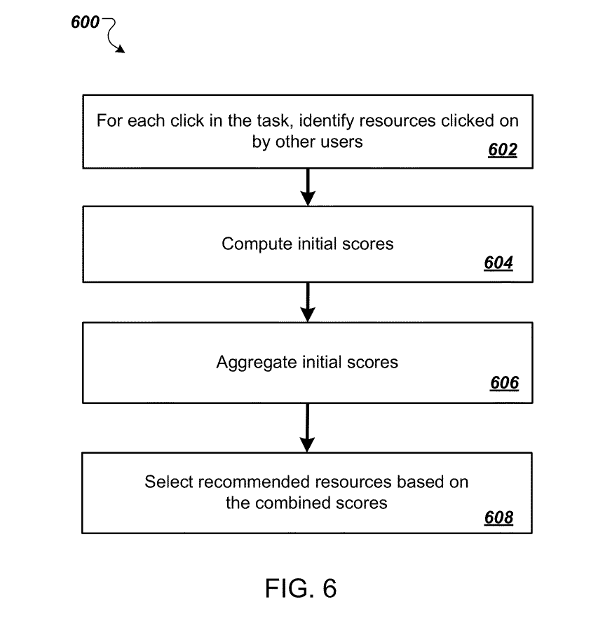

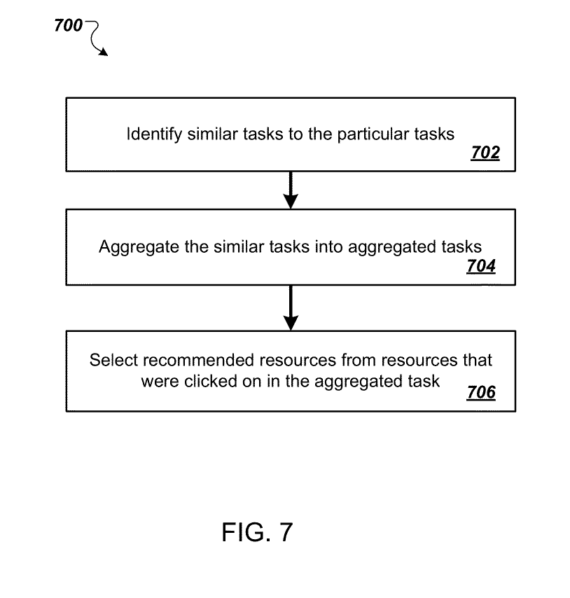

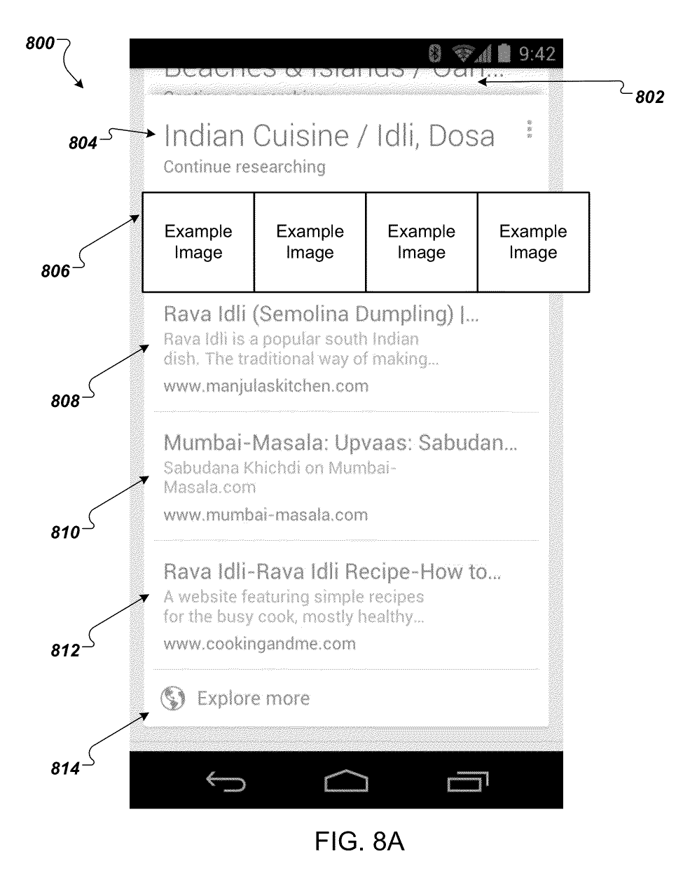

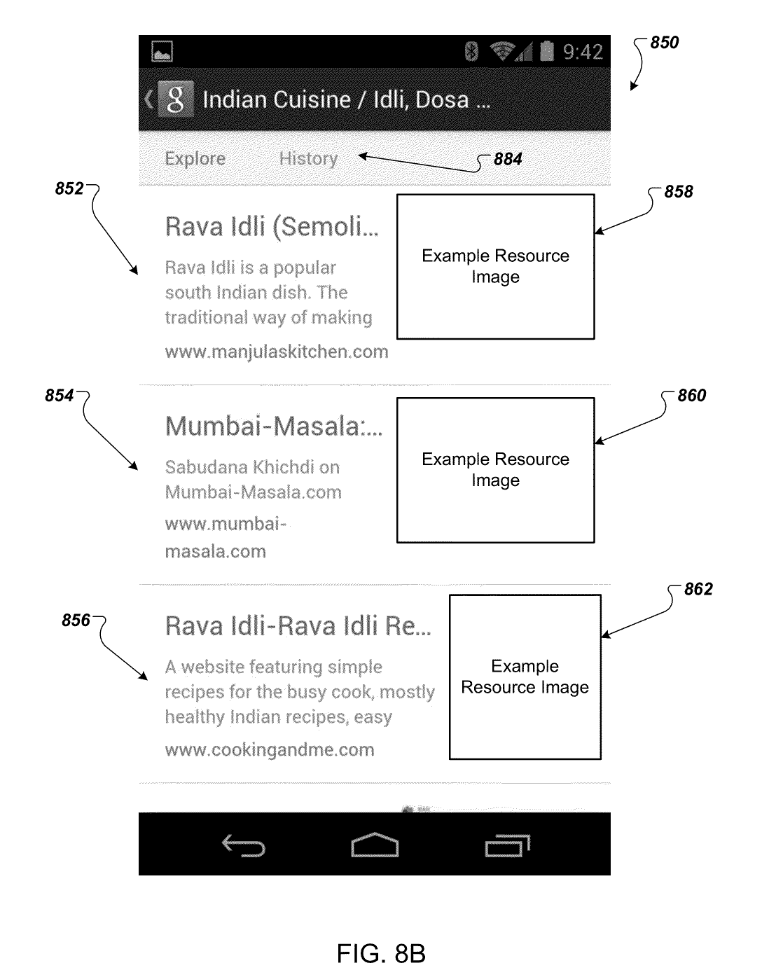

When a task request is received by the task system 114, the task generation engine 140 generates tasks that the user has previously engaged in using the observations associated with the user in the observation database 122 and the recommendation engine 150 generates recommended content for each of the tasks. In some implementations, the task system 114 responds to the task request by generating task presentations for each of the tasks that identify the task and include the recommended content and transmits the task presentations through the network to the user device 104 for presentation to the user 102. For example, a task presentation may be presented as part of a web page to be displayed by a web browser running on the user device 104 or in the user interface of a particular application running on the user device 104. Generating tasks from observations associated with a user is described in more detail below with reference to FIGS. 2 and 3. Generating recommendations for a task will be described in more detail below with reference to FIGS. 6 and 7. Example task presentations are described below with reference to FIGS. 8A and 8B. In some other implementations, the system may generate the task presentations for each of the tasks and store them, e.g., for presentation to the user 102 at a later time.

FIG. 2 is a flow diagram of an example process 200 for generating task presentations for tasks previously engaged in by a particular user. For convenience, the process 200 will be described as being performed by a system of one or more computers located in one or more locations. For example, a task system, e.g., the task system 114 of FIG. 1, appropriately programmed in accordance with this specification, can perform the process 200.

The system accesses an observation database, e.g., the observation database 122 of FIG. 1, to identify observations associated with the user (step 202). The system segments the observations into tasks previously engaged in by the user (step 204). Segmenting observations into tasks is described below with reference to FIG. 3.

The system generates recommendations for each of the tasks (step 206). Generally, the recommendations for a given task are generated based on observations associated with other users who have engaged in the same or similar tasks. Example techniques for generating recommendations for a given task are described in more detail below with reference to FIGS. 6 and 7.

The system generates a task presentation for each of the tasks (step 208). The task presentation for a given task will include a name for the task and the recommended content generated for the task. Example task presentations are described in more detail below with reference to FIGS. 8A and 8B.

The system provides the task presentations for presentation to the user (step 210).

FIG. 3 is a flow diagram of an example process 300 for segmenting observations into tasks. For convenience, the process 300 will be described as being performed by a system of one or more computers located in one or more locations. For example, a task system, e.g., the task system 114 of FIG. 1, appropriately programmed in accordance with this specification, can perform the process 300.

The system selects candidate pairs of segments to be merged into a single segment (step 302). A segment is a set of one or more observations. Initially, i.e., the first time the process 300 is performed in response to a given task request, each observation is assigned to a respective segment, i.e., so that each segment contains one observation.

The system can determine whether two segments are a candidate pair by considering any of a number of similarity signals that compare various characteristics of the observations included in the two segments. For example, the system can consider a similarity signal that measures whether the observations included in the two segments are sufficiently temporally adjacent. For example, the signal may measure the degree to which the observations in one segment were submitted by or, in the case of some indirect observations, e.g., an e-mail message, were received by the user within a pre-defined time window as an observation in the other segment.

As another example, the system can consider a signal that measures whether the two segments include a sufficient amount of the same or equivalent search queries. Two search queries may be considered to be equivalent if, when the two queries are rewritten to include synonyms for query terms, the two queries are the same.

As another example, in some implementations, the system may have access to data that classifies search queries, resources, or both, as belonging to one or more categories, relating to one or more entities, being relevant to one or more entity types, or otherwise semantically classifies the search query or resource. In these implementations, the system may consider a signal that measures whether the two segments include a sufficient number of observations that are classified by the data as having the same semantic classification.

As another example, the system annotates each observation in a segment with a type. The system can consider a signal that measures the degree to which observations in the segment have been assigned the same type or to semantically similar types. That is, the signal may indicate that a segment that includes a large proportion of observations that are assigned to different types from observations in another segment does not include similar observations to the other segment.

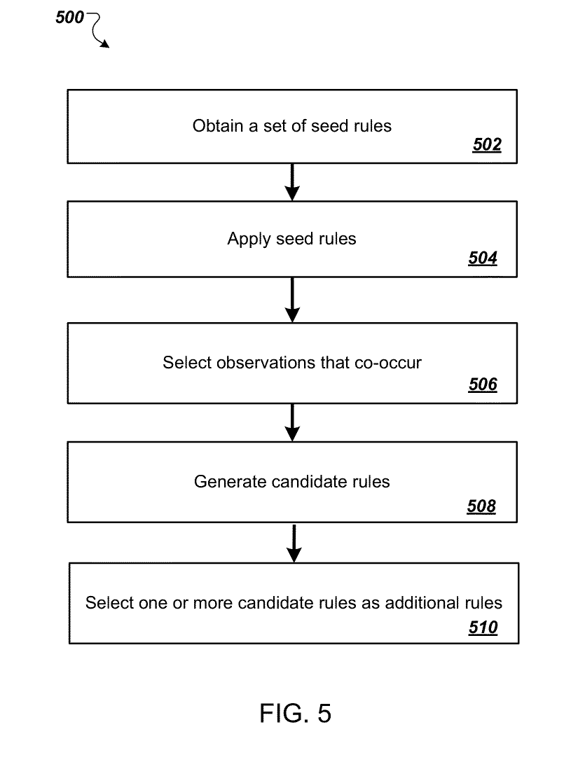

The system can assign observations in segments to a type by mapping the observations to one of a set of pre-determined types by applying a set of rules. Each rule identifies one of the pre-determined types and one or more observations that should be mapped to the type. Generating rules for mapping observations to types is described below with reference to FIG. 5.

As another example, the system may consider a signal that measures whether the search queries in the two segments share a sufficient amount or proportion of unigrams.

As another example, the system may consider a signal that measures the degree to which the same resources that have been classified as being of a particular type, e.g., forum resource, product resource, blog resource, or news resource, are identified by search results for search queries that are included in the two segments.

In some implementations, the system determines that each pair of segments for which at least a threshold number of similarity signals, e.g., at least one, two, or five similarity signals, indicate that the observations in the segments are similar is a candidate pair. Alternatively, the system may assign a weight to each of the similarity signals and compute a weighted sum of the values of the similarity signals for the two segments. The system can then determine that each pair of segments for which the weighted sum exceeds a threshold value is a candidate pair.

The system generates a similarity score for each candidate pair of segments using a similarity classifier (step 304). That is, the system provides a set of signal values for each candidate pair as an input to the similarity classifier, which uses a set of weights to combine the signals provided into a similarity score for the candidate pair. The weights can be manually specified. Alternatively, the similarity classifier may be trained using conventional machine learning techniques to obtain optimal values for the weights. Generally, for each candidate pair, the system provides one or more semantic signals, one or more selection-based signals, one or more word signals, and one or more temporal signals to the similarity classifier.

The semantic signals are signals that measure the semantic similarity between the observations in each candidate pair. For example, the semantic signals may include a signal that measures whether the segments have been assigned to the same or a semantically similar type. As another example, the system may have access to one or more services that generate query refinements for search queries. In these implementations, the semantic signals may include a signal that measures whether or not search queries in the two segments have similar query refinements.

The selection-based signals are signals that measure the degree of similarity between user selections of search results in each of the two segments. For example, the click-based signals may include a signal that measures the degree to which the two segments include clicks on search results identifying the same resource or resources in the same site. As another example, the click-based signals may include a signal that measures the degree to which the two segments include clicks on search results that identify distinct resources or resources in distinct sites that share terms in their title.

The system can be configured to treat different kinds of disjoint collections of resources as a site. For example, the system can treat as a site a collection of resources that are hosted on a particular server. In that case, resources in a site can be accessed through a network, e.g., the Internet, using an Internet address, e.g., a Uniform Resource Locator (URL), corresponding to a server on which the site is hosted. Alternatively or in addition, a site can be defined operationally as the resources in a domain, e.g., “example.com,” where the resources in the domain, e.g., “host.example.com/resource1,” “www.example.com/folder/resource2,” or “example.com/resource3,” are in the site. Alternatively or in addition, a site can be defined operationally using a subdomain, e.g., “www.example.com,” where the resources in the subdomain, e.g., “www.example.com/resource1” or “www.example.com/folder/resource2,” are in the site. Alternatively or in addition, a site can be defined operationally using a subdirectory, e.g., “example.com/subdirectory,” where the resources in the subdirectory, e.g., “example.com/subdirectory/resource.html,” are in the site.

The word signals are signals that measure the textual similarity of search queries in the two segments. For example, the words signals may include a signal that measures the degree to which the two segments include search queries that share one or more unigrams, higher-level n-grams, or both. As another example, the word signals may include a signal that measures the degree to which the two segments include search queries that are equivalent.

The temporal signals are signals that measure the degree to which the observations in the two segments are temporally similar. For example, the temporal signals may include a signal that measures the degree to which the two segments contain search queries that are temporally adjacent to each other. As another example, the temporal signals may include a signal that measures the degree to which the two segments contain search queries or clicks that were submitted by the user during the same visit. Two queries or clicks may be considered to have been submitted during the same visit if they are both included in a sequence of queries and clicks, with the time difference between any two successive events in the sequence not exceeding a threshold value.

The system merges candidate pairs that are similar (step 306). The system can determine that each candidate pair of signals for which the similarity score exceeds a threshold score are to be merged. Optionally, the system may also require that the number of signals that indicate that the candidate pair should be merged exceed the number of signals that indicate that the candidate pair should not be merged by a threshold number. Further optionally, the threshold score, the threshold number, or both may increase for each iteration of the merging process. That is, the criteria for determining that a candidate pair of segments be merged may become more stringent for each subsequent iteration of the merging process that the system performs.

The system annotates each segment with a task type (step 308). Generally, the system assigns a type to each observation in the segment using the set of rules and aggregates the types assigned to the queries in the segment to generate the task type for the segment. In aggregating the types assigned to the queries, the system can, for example, select the type that has been assigned to the largest number of observations in the segment as the task type for the segment. Optionally, each of the types assigned to observations may be associated with a weight that represents a confidence level that the type assigned to the observation is the correct type for the observation. In these cases, the system may sum the weights for each type and select the type that has the highest sum as the task type for the segment.

Further optionally, prior to selecting a type as the task type, the system can verify that the type explains at least a threshold number of the observations in the segment, e.g., a number that is on the order of the square root of the number of observations in the segment. The system may consider a type to explain an observation if the type is the same as the type for the observation or if the type is sufficiently semantically similar to the type for the observation.

The system determines whether termination criteria are satisfied (step 310). For example, the system may determine that the termination criteria are satisfied when, after merging the candidate pairs that are similar, none of the remaining segments are candidates for merging.

If the termination criteria are not satisfied, the system repeats step 302. If the termination criteria are satisfied, the system generates task scores for each of the remaining segments (step 312). The system can generate the task score for a segment based in part on segment significance, segment coherence, or both. Segment significance measures the size of the segment. That is, segment significance generally measures the number of observations in the segment relative to the total number of observations associated with the user. The system can assign a higher task score to a segment than to an otherwise equivalent segment that has a lower segment significance measure. Segment coherence measures how focused the observations in the segment are, i.e., so that segments that have more focused observations are assigned higher segment coherence measures. For example, segment coherence can be computed based at least in part on the number of visits in the segments, and the number of observations per visit in the segment. The system can assign a higher task score to a segment than to an otherwise equivalent segment that has a lower segment coherence measure.

The system selects tasks from the remaining segments based on the task scores (step 314). For example, the system can select each segment having a task score above a particular threshold as a task or a pre-determined number of segments having the highest task scores as tasks. Once the tasks have been selected, the system may optionally adjust the order of the selected tasks, e.g., to promote tasks that have higher segment coherence measures or to demote navigational tasks or tasks that were only engaged in during a single visit, i.e., because the user may be more likely to have already satisfied their information need for tasks that are being demoted.

Once the system has selected tasks from the remaining segments, the system assigns a name to the task. The name can be generated using any of a variety of signals. For example, the signals can include one or more of search queries in the task, words in queries in the task, titles of resources that have received clicks in the task, names and descriptions of entities referred to in the task, task types of the task and others.

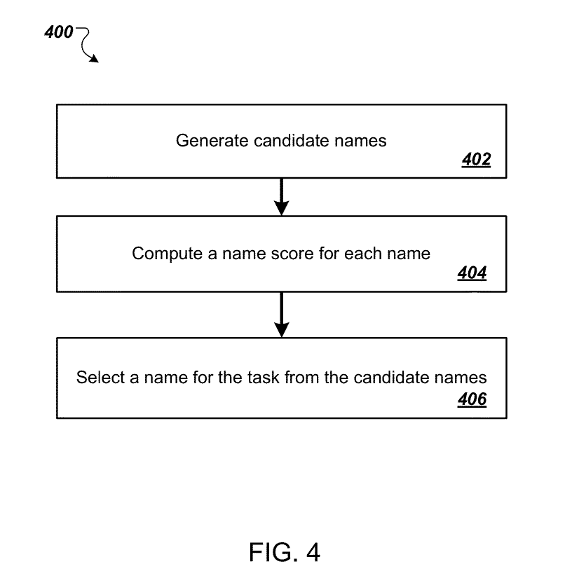

FIG. 4 is a flow diagram of an example process 400 for generating a name for a task. For convenience, the process 400 will be described as being performed by a system of one or more computers located in one or more locations. For example, a task system, e.g., the task system 114 of FIG. 1, appropriately programmed in accordance with this specification, can perform the process 400.

The system generates candidate names for the task from the observations in the task (step 402). That is, the system selects text associated with observations in the task as candidate names in accordance with pre-determined selection criteria.

For example, the criteria may specify that all or some of the text of each search query in the task or each search query that has been submitted by the user more than a threshold number of times be selected as a candidate name. For example, the criteria may specify that every possible subset of n-grams that are included in the query be considered as a candidate name. That is, for the search query “cheap Atlanta hotels,” the system may select “cheap,” “Atlanta,” “hotels,” “cheap Atlanta,” “Atlanta hotels,” and “cheap Atlanta hotels” as candidate names for a task that includes the search query.

Similarly, the criteria may specify that some or all of the text of search queries that are related to the search queries in the task be selected as a candidate name. Related queries for a given search query may include query refinements for the search query, queries that include synonyms of terms in the search query, or both.

As another example, the criteria may specify that n-grams from titles of resources visited in the task be selected as a candidate name. For example, the criteria may specify that each possible subset of n-grams included in the title that includes a recognized reference to an entity or entity type be considered as a candidate name.

As another example, in implementations where the system has access to data that classifies search queries, resources, or both, as belonging to one or more categories, relating to one or more entities, or being relevant to one or more entity types, the criteria may specify that category labels, entity names, and entity types associated with search queries or resources in the task be considered as candidate names for the task.

In some implementations, some of the criteria are specific to the type of the task. For example, for tasks of the type “travel,” one of the criteria may specify that a candidate name for the task be “Travel to [Location],” where the value of the [Location] attribute is generated from entities that are relevant to queries or resources in the task.

In some implementations, the task names have the form of “[Category Name]/[Specific Name].” That is, an example task name for a task that includes observations that relate to researching for a future trip to Buenos Aires, Argentina might be “Travel/Travel to Buenos Aires,” where “Travel” is the category name for the task and “Travel to Buenos Aires” is the specific name for the task. In these implementations, the criteria also specify whether the category name generated by applying the category name is a candidate category name for the task or a candidate specific name for the task. In some cases, candidate names generated using certain criteria may be considered as both a candidate category name and a candidate specific name for the task.

The system computes a name score for each candidate name (step 404). Generally, the name score for a candidate name measures how well the candidate name describes the observations in the task. In particular, for each candidate name, the system computes multiple pair-wise similarity scores and aggregates the similarity scores to generate the name score for the candidate name. Each pair-wise similarity score measures the similarity between the candidate name and a respective observation in the task. For example, the system may compute a respective pair-wise similarity score between the candidate name and each observation in the task.

The system can compute the respective pair-wise similarity scores by treating the candidate name and the observation as single-observation segments and generating the pair-wise similarity score for the single-observation segments using the similarity score classifier described above with reference to FIG. 3. That is, the system can provide values of one or more semantic signals for the single-observation segments and values of one or more word signals for the single-observation segments to the classifier in order to obtain the pair-wise similarity scores.

The system can aggregate the pair-wise similarity scores to generate the name score for the candidate. The system can aggregate the pair-wise similarity scores in any of a variety of ways. For example, the system can compute an arithmetic mean of the pair-wise scores, a geometric mean of the pair-wise scores, a sum of the pair-wise scores or a product of the pair-wise scores.

In implementations where the task names have the form of “[Category Name][/Specific Name],” the system can aggregate candidate category names and candidate specific names separately.

The system selects a name for the task from the candidate names using the task scores (step 406). For example, the system can select the candidate name having the highest task score as the name for the task. In implementations where the task names have the form of “[Category Name][/Specific Name],” the system may select the highest-scoring candidate category name and the highest-scoring candidate specific name as the category name and the specific name for the task, respectively.

Once the name for a task is generated, it can be used to identify the task, e.g., in a task presentation that includes information identifying observations in the task and recommended content for the task.

FIG. 5 is a flow diagram of an example process 500 for generating rules for mapping observations to types. For convenience, the process 500 will be described as being performed by a system of one or more computers located in one or more locations. For example, a task system, e.g., the task system 114 of FIG. 1, appropriately programmed in accordance with this specification, can perform the process 500.

The system obtains a set of seed rules for mapping observations to types (step 502). Each seed rule identifies a respective one of a predetermined set of types and one or more observations that should be mapped to the type.

The system applies the seed rules to a set of observations to generate an initial set of observation-type pairs (step 504). For example, the system can apply the seed rules to a subset or all of the observations in the observation database 122 of FIG. 1.

The system selects observations that co-occur with observations in the initial set of observation-type pairs (step 506). For example, the system can determine that one observation co-occurs with another observation when, if both observations are resource visits, both observations occurred after submitting the same search query or an equivalent search query. As another example, the system can determine that one observation co-occurs with another observation when both observations are included in the same task. As another example, the system can determine that one observation co-occurs with another observation when both observations are associated with the same user.

The system generates one or more candidate rules for each co-occurring observation (step 508). That is, the system generates a candidate rule that maps the co-occurring observation to the same type as the observation in the initial set with which the co-occurring observation co-occurs. Optionally, the system can also generate additional candidate rules that, for observations that are search queries, include one or more of the possible subsets of n-grams in the search query, and, for observations that are resources, include other resources in the same site as the resource, and so on.

The system selects one or more of the candidate rules as additional rules to generate a new set of rules that includes the seed rule and the additional rules (step 510). In order to select the additional rules, the system scores each candidate rule and selects each candidate rule having a score above a threshold value as an additional rule.

Generally, the system scores each candidate rule so that candidate rules that map a larger number of observations in the set of co-occurring observations to a type relative to the number of observations mapped by the rule that are in the set of observations but not in the set of co-occurring observations score higher than other candidate rules that map a relatively smaller number of observations number of observations in the set of co-occurring observations to a type relative to the number of observations mapped by the rule that are in the set of observations but not in the set of co-occurring observations. In particular, the system scores each candidate rule on the candidate rule's precision, recall and lift relative to the other candidate rules.

The system can repeat steps 504 through 510 multiple times, using the new set of rules from the preceding iteration as the seed rules for the current iteration, in order to determine a final set of rules for mapping observations to types.

FIG. 6 is a flow diagram of an example process 600 for generating recommended content for a particular task. For convenience, the process 600 will be described as being performed by a system of one or more computers located in one or more locations. For example, a task system, e.g., the task system 114 of FIG. 1, appropriately programmed in accordance with this specification, can perform the process 600.

For each click on a resource in the task, the system identifies resources clicked on by other users that also clicked on the resource (step 602). A click on a resource can be, e.g., a click on a search result identifying the resource or a click on another link that links to the resource. That is, the system can identify, for each click on the clicked resource by another user, clicks by the other user that are in the same task as a click on the clicked resource.

The system computes initial scores for the identified resources (step 604). For example, the system can compute the scores based on the likelihood that each user clicked on the identified resource as part of the same task as a click on the clicked resource, with resources having a greater likelihood of being clicked on as part of the same task as the clicked resource receiving higher initial scores.

The system aggregates the initial scores to generate combined scores for the resources clicked on by other users (step 606). That is, for each resource that was assigned more than one initial score, the system aggregates the initial scores for the resource to generate a combined score for the resource, e.g., by computing an average of the initial scores or a sum of the initial scores.

The system selects recommended resources based on the combined scores (step 608). For example, the system can select each resource having a combined score above a pre-determined threshold or a pre-determined number of highest-scoring resources as recommended resources. In some implementations, the system adjusts the scores based on data available to the system that measures the quality of the resources and to increase the diversity of the recommended resources. In some implementations, the system selects respective pre-determined number of resources of multiple types. For example, the system can select the two highest-scoring news articles and the highest-scoring online encyclopedia pages.

FIG. 7 is a flow diagram of another example process 700 for generating recommended content for a particular task. For convenience, the process 700 will be described as being performed by a system of one or more computers located in one or more locations. For example, a task system, e.g., the task system 114 of FIG. 1, appropriately programmed in accordance with this specification, can perform the process 700.

The system identifies similar tasks to the particular task (step 702). The system identifies the similar tasks from among tasks that were engaged in by other users, i.e., that were generated by the system from observations associated with other users. In some implementations, the system selects as similar tasks the tasks that, had they been engaged in by the current user, would have been selected as a candidate segment to be merged with the particular task, e.g., as described above with reference to FIG. 3. In some other implementations, the system can select the similar tasks by considering a different subset of the similarity signals considered by the system when determining whether two segments are a candidate pair for merging. In yet other implementations, the system can select as similar tasks the tasks that, had they been engaged in by the current user, would have been merged with the particular task based on the score assigned by the similarity classifier, e.g., as described above with reference FIG. 3.

In yet other implementations, the system can cluster all tasks around one or more different axes, where each axis is a set of one or more features of the particular task, such as a query, a clicked resource, relevant entities, words in queries or titles, and so on. For each of the axes, the system identifies tasks sharing each of the particular set of features as similar tasks.

The system aggregates the similar tasks into one or more aggregated tasks (step 704). For example, the system can merge the similar tasks, e.g., as described above with reference to FIG. 3, resulting in one or more aggregated tasks. As another example, the system can cluster the similar tasks into smaller sets, e.g., using K-Means or Hierarchical Agglomerated Clustering techniques. The system then constructs one aggregate task for each set of clustered similar tasks.

The system generates recommendations based on observations in the aggregated tasks (step 708). For example, the system can rank the aggregate tasks according to their similarity with the user task along various dimensions, e.g., queries, clicks, entities words, and so on, and then select the top-ranking aggregate tasks as the most relevant tasks. From the most relevant aggregate tasks, the system constructs recommendations for the particular task. A recommendation can be a resource that was clicked on in an aggregate task, but may also be, e.g., an entity associated with an aggregate task or any other observation in an aggregate task. The system selects the recommendations based on how many aggregate tasks recommend it. Optionally, the system can apply a series of transformations to the ranking to improve the order of recommendations. For example, the transformations can include one or more of: preventing recommendations from the same aggregate task showing up more than a threshold number of times, not showing recommendations that are the same or very similar to what the user has already seen, i.e., that recommend content that is the same or very similar to content identified by observations in the particular task, giving slightly higher weight to recommendations from smaller sources, removing very similar recommendations to reduce repetition and increase diversity, and so on.

Once the system has selected the recommended resources, e.g., using the process 400 or the process 700, the system generates recommended content that identifies the recommended resources. For example, the recommended content may include a link to the recommended resource and one or more of the title of the recommended resource, a summary of the content of the recommended resource, or an image from the recommended resource. For recommendations that are not resources but that are, e.g., entities associated with the aggregate task or a different kind of observation in the task, the recommend content may include a link to submit a search query to obtain more information about the recommendation, or a link to an authoritative resource for the recommendation.

FIG. 8A shows an example task presentation 800 displayed on a mobile device. The task presentation 800 includes recommended content for an “Indian Cuisine/Idli, Dosa” task 804 previously engaged in by a user of the mobile device. The user may be able to navigate to other tasks that the user has previously engaged by way of, e.g., a touch input on the mobile device. For example, the user may be able to navigate to a “Beaches & Islands” task 802 by swiping down on the touchscreen display of the mobile device.

The task presentation 800 includes an image 806 that describes the task. For example, the image 806 may have been generated from images included in resources clicked on by the user while engaging in the task 804.

The task presentation 800 includes titles 808, 810, and 812 of recommended resources that are displayed in the form of links to the recommended resources. The task presentation 800 also includes an “Explore more” link 814 that allows the user to navigate to an expanded task presentation that provides more information about the task 804 and the recommended resources.

FIG. 8B shows an example expanded task presentation 850. The expanded task presentation 850 can be an expanded version of the task presentation 800 of FIG. 8A, and may have been navigated to by a user by selecting the “Explore more” link 814 of FIG. 8A. The expanded task presentation 850 includes additional information about the recommended resources for the “Indian Cuisine/Idli, Dosa” task 804. In particular, the expanded task presentation includes respective summaries 852, 854, and 856 and respective images 858, 860, and 862 of recommended resources for the task 804. Additionally, the expanded task presentation 850 includes a “history” element 864. When a user selects the “history” element 864, the user can be presented with information identifying the observations that are in the task. For example, the user may be presented with information about resources that the user has frequently clicked on while engaging in the task or search queries that the user has frequently submitted while engaging in the task.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
segmenting a plurality of observations associated with a user of a user device into a plurality of tasks previously engaged in by the user; and
generating a respective task presentation for each of the plurality of tasks for presentation to the user.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)
